(19) United States
(12) Patent Application Publication
(10) Pub. No.: US 2026/0111401 A1
(43) Pub. Date: Apr. 23, 2026

(54) METHOD AND SYSTEM FOR HIGHLY SCALABLE ASYNCHRONOUS MAINTENANCE OF AN INVERTED INDEX

(71) Applicant: Oracle International Corporation, Redwood Shores, CA (US)

(72) Inventor: Denis Mukhin, Southborough, MA (US)

(73) Assignee: Oracle International Corporation, Redwood Shores, CA (US)

(21) Appl. No.: 18/922,305

(22) Filed: Oct. 21, 2024

(51) Int. Cl. G06F 16/22

(52) U.S. Cl. CPC G06F 16/22

(57) ABSTRACT

Provided is an improved approach to implement maintenance of inverted indexes, where asynchronous maintenance is performed in a very efficient and highly scalable manner. As a result, it becomes possible to keep search results as close to current as possible, thus allowing the asynchronous maintenance to be fast enough to reach full transactional consistency.

A text index is a data structure used to facilitate full-text search over unstructured text. The structure of a text index is typically an inverted index that maps individual tokens to a list of documents that contain them. Each token and its associated list are called a posting. When users issue full-text queries, the inverted index postings are consulted to efficiently find documents that contain tokens in the queries.

In a relational database management system (RDBMS), document collections are represented by tables and individual documents by columns of a table. When collections of documents change with time, any associated inverted indexes should also be updated so that the result of searches match the current version of the collection.

It is normally considered very expensive to maintain an inverted index, given the large number of interrelated table structures that need to be accessed, processed, and potentially modified when a change occurs to the underlying documents table. This problem is further exacerbated by the large amount of content that may need to be processed to implement maintenance of the inverted indexes. For conventional systems, this means that inefficient asynchronous approaches are usually taken to maintain the inverted indexes. As a result, it is common for the inverted index to become out-of-date, causing search results to represent some time period in the past and not necessarily the most recent version of the document collection.

Therefore, there is a need for an improved approach to address the above problems within a database system.

### SUMMARY

Some embodiments of the invention provide an improved approach to implement maintenance of inverted indexes, where asynchronous maintenance is performed in a very efficient and highly scalable manner. As a result, it becomes possible to keep search results as close to current as possible, thus allowing the asynchronous maintenance to be fast enough to reach full transactional consistency.

Further details of aspects, objects and advantages of the disclosure are described below in the detailed description, drawings and claims. Both the foregoing general description and the following detailed description are exemplary and explanatory, and are not intended to be limiting as to the scope of the disclosure.

### BRIEF DESCRIPTION OF FIGURES

The drawings illustrate the design and utility of some embodiments of the present disclosure. It should be noted that the figures are not drawn to scale and that elements of similar structures or functions are represented by like reference numerals throughout the figures. In order to better appreciate how to obtain the above-recited and other advantages and objects of various embodiments of the disclosure, a more detailed description of the present disclosure briefly described above will be rendered by reference to specific embodiments thereof, which are illustrated in the accompanying drawings. Understanding that these drawings depict only typical embodiments of the disclosure and are not therefore to be considered limiting of its scope.

The drawings use like reference numerals to identify like elements. A letter after a reference numeral, such as “120a,” indicates that the text refers specifically to the element having that particular reference numeral. A reference numeral in the text without a following letter, such as “120,” refers to any or all of the elements in the drawings bearing that reference numeral (e.g., “120” in the text refers to reference numerals “120a” and/or “120b” in the drawings). The disclosure will be described and explained with additional specificity and detail through the use of the accompanying drawings in which:

FIG. 1 shows an example database environment in which some embodiments of the invention may be implemented.

FIG. 2 shows a high-level flowchart to implement some embodiments of the invention.

FIG. 3 shows a more detailed flowchart of actions that are taken according to some embodiments of the invention.

FIGS. 4A-J provide an illustrative example of this process.

FIG. 5 shows a flowchart of an approach to implement some embodiments of the invention.

FIG. 6 shows an example event queue according to some embodiments of the invention.

FIG. 7 illustrates a block diagram of an illustrative computing system suitable for implementing an embodiment of the present disclosure.

FIG. 8 illustrates a block diagram of one or more components of a system environment by which more efficient access to ordered sequences in a database environment is provided, in accordance with an embodiment of the present disclosure.

### DETAILED DESCRIPTION

Various embodiments will now be described in detail, which are provided as illustrative examples of the disclosure so as to enable those skilled in the art to practice the disclosure. Notably, the figures and the examples below are not meant to limit the scope of the present disclosure. Where certain elements of the present disclosure may be partially or fully implemented using known components (or methods or processes), only those portions of such known components (or methods or processes) that are necessary for an understanding of the present disclosure will be described, and the detailed descriptions of other portions of such known components (or methods or processes) will be omitted so as not to obscure the disclosure. Further, various embodiments encompass present and future known equivalents to the components referred to herein by way of illustration.

Some of the terms used in this description are defined below for easy reference. The presented terms and their respective definitions are not rigidly restricted to these definitions—a term may be further defined by the term's use within this disclosure. As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances. As used herein, at least one of A or B means at least one of A, or at least one of B, or at least one of both A and B. In other words, this phrase is disjunctive. The articles “a” and “an” as used in this application and the appended claims should generally be construed to mean “one or more” unless specified otherwise or is clear from the context to be directed to a singular form.

Some embodiments of the invention provide an improved approach to implement maintenance of inverted indexes, where asynchronous maintenance is performed in a very efficient and highly scalable manner. As a result, it becomes possible to keep search results as close to current as possible, thus allowing the asynchronous maintenance to be fast enough to reach full transactional consistency.

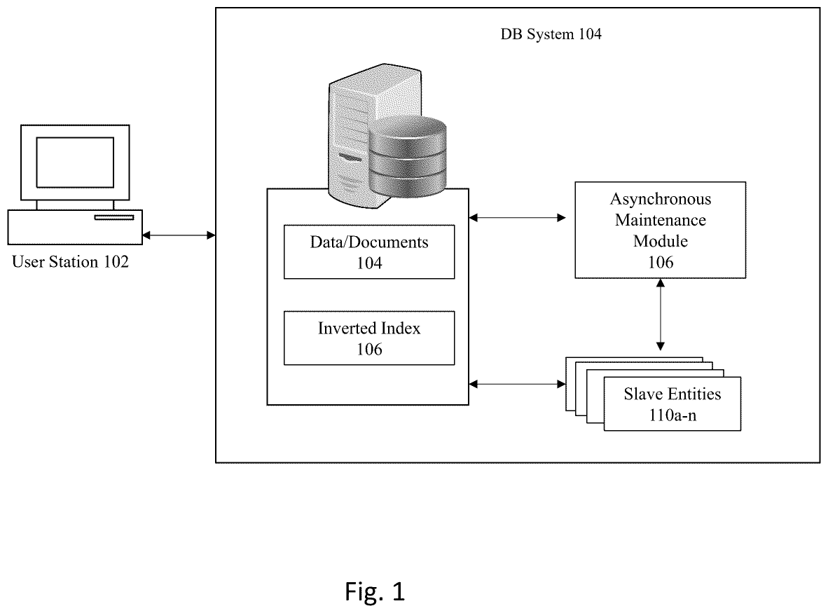

FIG. 1 shows an example database environment 100 in which some embodiments of the invention may be implemented. The database environment 100 may include one or more users or database applications within the system that operate from or using a user station 102 to issue commands to be processed by a database system 104 (e.g., a database management system (DBMS)) upon one or more database tables. The user stations and/or the servers in the database system comprises any type of computing device that may be used to implement, operate, or interface with the database. Examples of such devices include, for example, workstations, personal computers, mobile devices, servers, hosts, nodes, or remote computing terminals. The user station comprises a display device, such as a display monitor, for displaying a user interface to users at the user station. The user station also comprises one or more input devices for the user to provide operational control over the activities of the system, such as a mouse or keyboard to manipulate a pointing object in a graphical user interface to generate user inputs.

The database system may be communicatively coupled to a storage device (e.g., a storage subsystem or appliance) over a network. The storage device comprises any storage mechanism that may be employed by the database system to hold storage content, such as but not limited to a hard disk drive, SSD, persistent memory, storage array, network attached storage, etc. The storage for the database may include any number of data storage devices and/or objects that are stored within the system, and which consume storage space on the database storage.

The database may include data/documents 104 that are stored within the database. The database may also include one or more inverted indexes 106. Inverted indexes are data structures that are used for efficient text searches of document collections based on words. In an RDBMS, document collections are represented by tables and individual documents by columns of a table. When collections of documents change with time inverted indexes should be updated so that the result of searches match the current version of the collection.

Normally, other types of RDBMS indexes such as b-tree or bitmap indexes are maintained synchronously with the changes that are made to the database, e.g., based on “DML” (data manipulation language) operations. However, doing the same for inverted indexes is prohibitively expensive and thus inverted indexes are usually maintained asynchronously. As a result, it is common for search results to represent some snapshot in the past and not necessarily the last version of the document collection.

To keep the results as close to current as possible, embodiments of the invention provide for an asynchronous maintenance module 106 that is capable of performing asynchronous maintenance in a fast and efficient manner, which allows some embodiments to reaching full or near-full transactional consistency. The current embodiment is able to achieve high concurrency in asynchronous maintenance based on the use of background processing entities (e.g., slave entities 110a-n) and efficient partitioning of the maintenance workload by module 106. The processing entities may be implemented as any type of entity in a computing system that is capable of performing work. Examples of such processing entities include a process, thread, container, virtual machine, application, service, or any other useful type of processing entity.

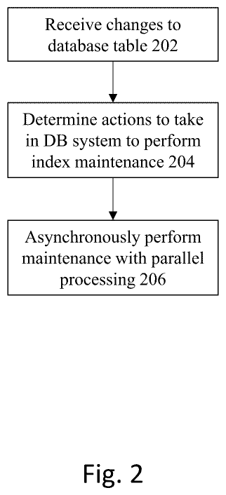

FIG. 2 shows a high-level flowchart to implement some embodiments of the invention. At 202, changes are received to the database table(s) for the document collection. Such changes may include, for example, instructions to insert, delete, or modify entries in the database table with regards to documents. These will likely involve the performance of DML operations against the document collection.

At 204, a determination is made of actions that need to be taken to perform the corresponding index maintenance tasks. As described in more detail below, the index maintenance tasks can be organized into different phases of operations. In addition, some of the phases of operations may have their work partitioned into different sets of work that can be separately and independently allocated to multiple different worker/slave entities.

At 206, the maintenance operations are then performed asynchronously to implement maintenance to the inverted indexes. At some of the different phases of the maintenance operations, parallel sets of slaves will be used to perform the work that is necessary for the maintenance.

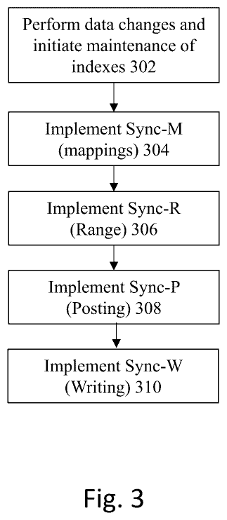

FIG. 3 shows a more detailed flowchart of actions that are taken according to some embodiments of the invention. At 302, data changes are performed and maintenance operations are initiated. To set up asynchronous index maintenance during data changes (e,g., for DMLs) the system will synchronously record for each modification a document identifier (ROWID), type of operation (INSERT, DELETE or UPDATE), time of change (SCN), and transaction identifier (XID). The data structure that maintains these tuples is called a journal and is stored in shared memory pages.

Periodically, or once close to be full, journal pages are flushed to disk (e.g., an internal table) by a background process even before a current transaction COMMITs. On COMMIT the flushing of pages is forced (in case it has not started yet) and COMMIT waits for the flush to finish synchronously.

The journal should be transactionally consistent as it is the source of truth for the inverted index and represents the basis for computing or restoring all other parts of the inverted index. The contents of the journal pages remain in memory as a cache with the oldest changes kept in memory (LRU cache). Journal pages are flushed by a dedicated set of background processes that only do flushing. Another set of backgrounds work on processing in-memory journal (only committed) and if necessary, preload on demand missing journal pages. Once the page is flushed and processed it is removed and scheduled to be replaced with another page from disk so that it can be processed next.

At 304, the system will implement the Sync-M stage. Journal pages are processed by Sync-M (mappings) algorithm for DocID values. A set of DocIDs is a set of increasing integers that are assigned to each document. The use of DocIDs is used when natural document identifiers do not have the property of being a set for increasing integers (as the case for certain RDBMSes). With some embodiments, a mapping table is maintained that correlates the assigned DocID value with a given Row ID for a document.

On COMMIT or ROLLBACK, a transaction XID is marked as committed or rolled back in the journal. On ROLLBACK the system does not wait for remaining pages to flush, instead it sends a request to backgrounds to stop the flushing and invalidate journal pages so that they can be purged. When processing Sync-M those pages will be ignored. The system also schedules DELETEs from the on-disk journal instead of INSERTs for invalid buffers and for processed buffers.

For processed buffers DELETEs from on-disk journal happen in the same transaction as DMLs on on-disk DocID mapping table. For the initial index creation there is a choice of either blocking all the way until all rows are processed (both ONLINE or not) and is a traditional approach for indexing or finishing only Sync-M part and then switching to background indexing. A special bulk version of Sync-M creates on-disk mapping table for all ROWIDs in the base table either blocking DMLs or possibly redirecting them to the journal as with regular DMLs. This concludes processing up to Sync-M. DocIDs are allocated but no processing of documents has yet been done.

At 306, the next stage that is processed is Sync-R (ranges). The Sync-R stage is performed to subdivide the workload into different DocID ranges, e.g., where Sync-R works with DocID ranges in the on-disk range bookkeeping catalog that were INSERTed by Sync-M. Each range represents the DocIDs that were allocated to all new documents by each Sync-M process. Sync-R coarsens all the available ranges and then splits them into equal ranges to allow for concurrent processing. The size is determined dynamically per index and constantly adjusted based on moving averages. The values are stored per index in the metadata section of the ranges bookkeeping catalog. Each range is allocated to take no more than 3 sec.

At 308, the actual generation of the inverted index postings lists is done during Sync-P (postings). Sync-P reads original documents from the base table based on the range. The result of Sync-P are postings lists into an in-memory cache.

At 310, the postings lists are written out to disk during the Sync-W (writing) phase. Sync-W is implemented similarly to how DML journal entries are written except that postings are completely recoverable in case of instance crash. There is a separate set of background processes for writing out posting lists.

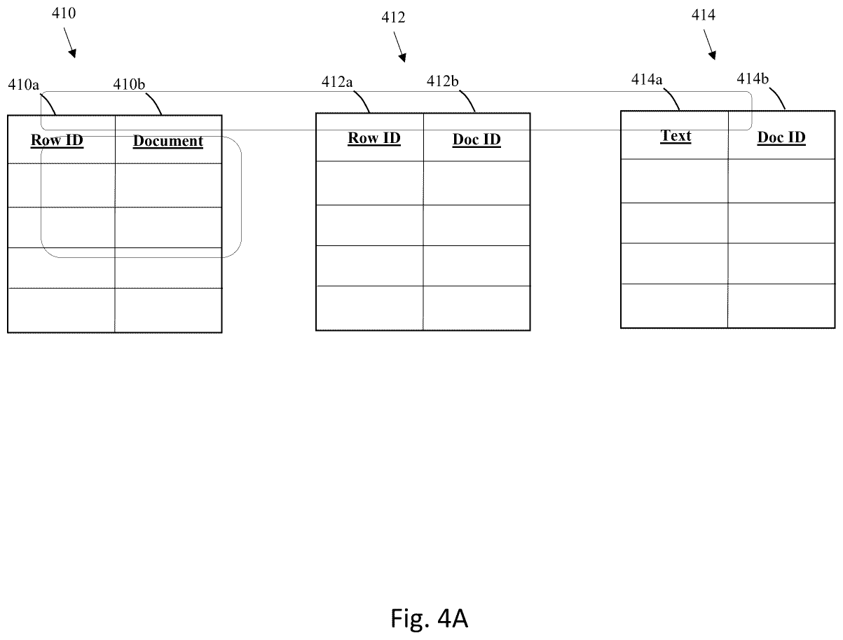

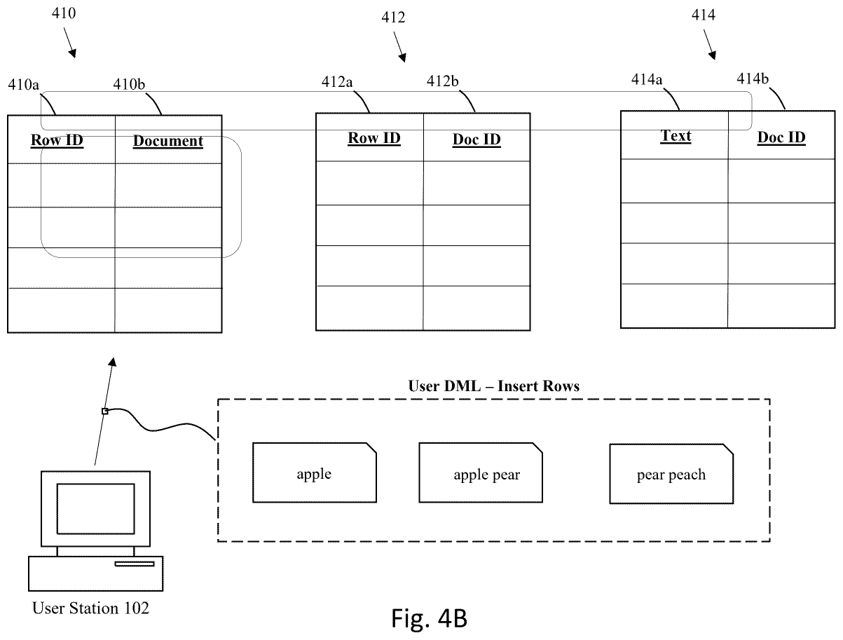

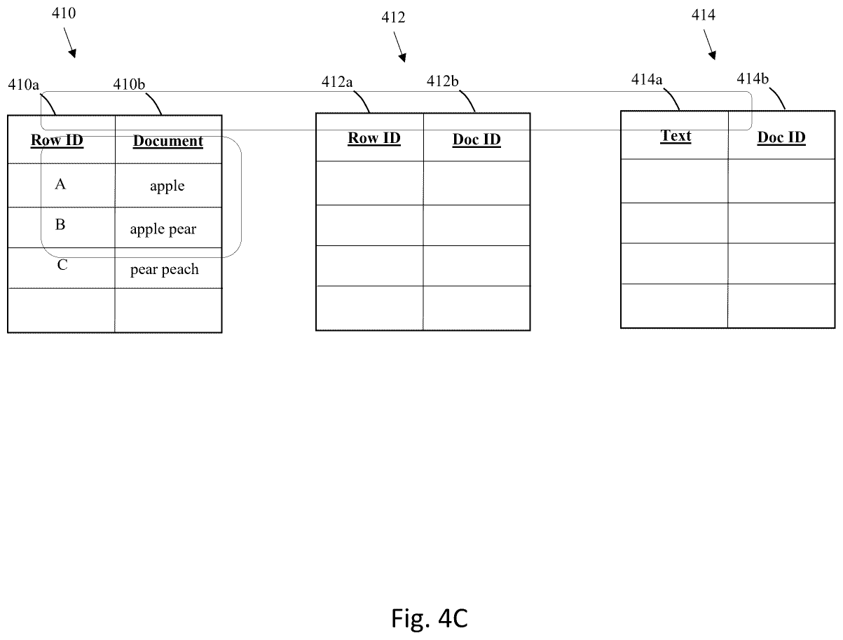

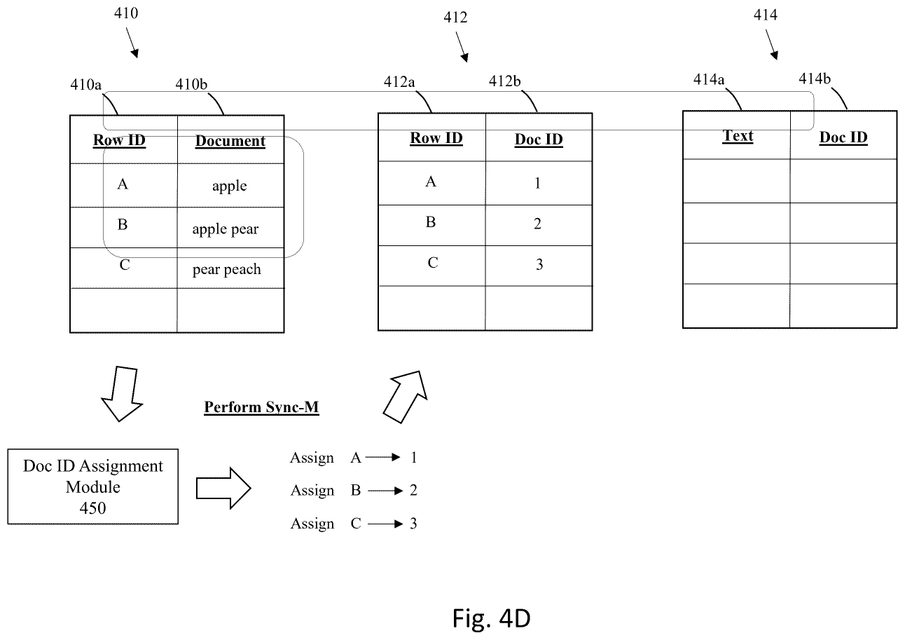

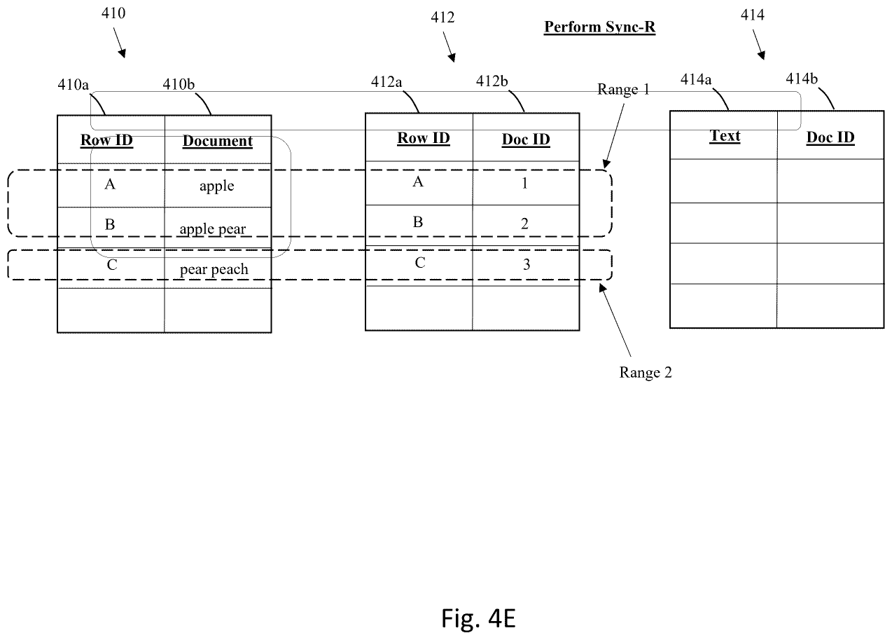

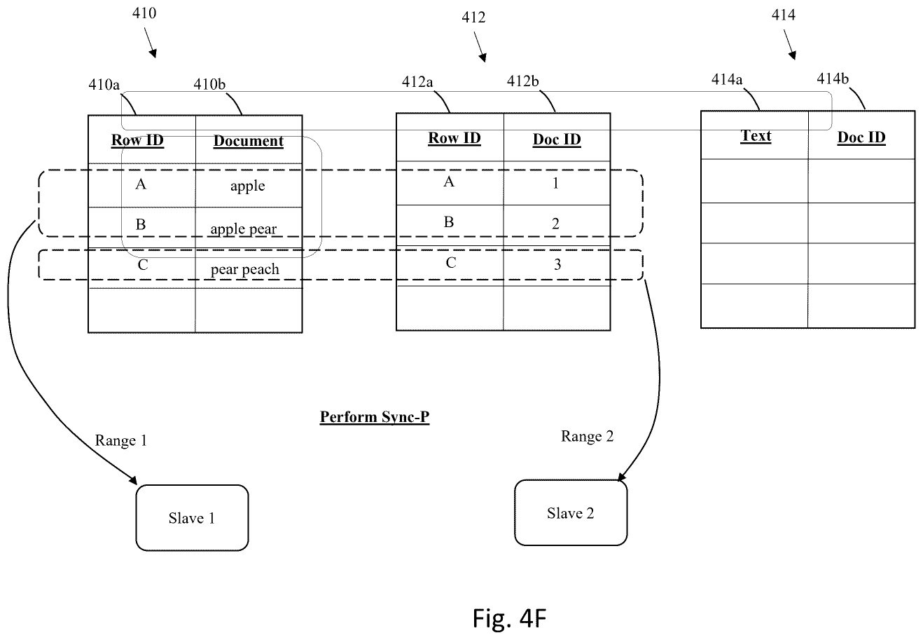

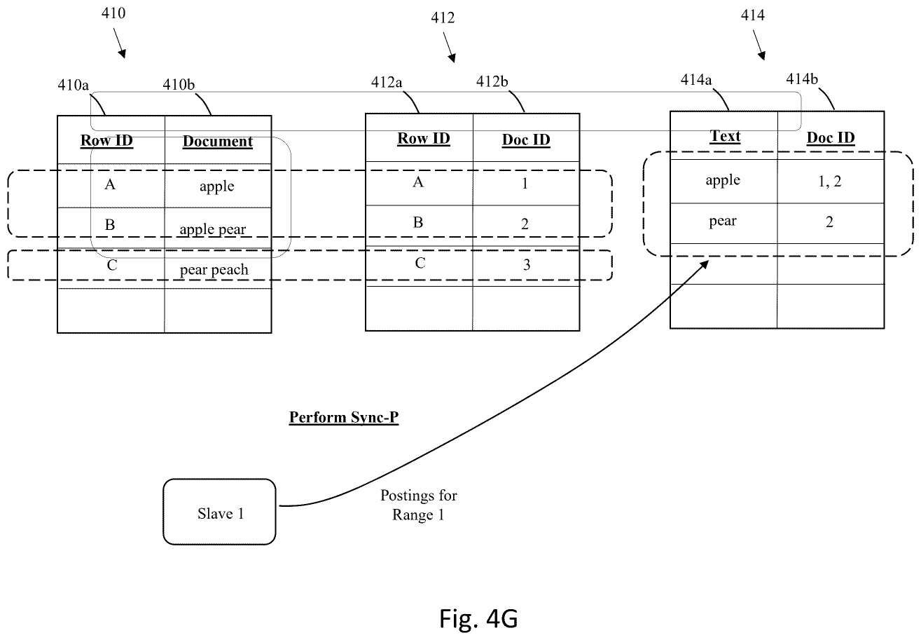

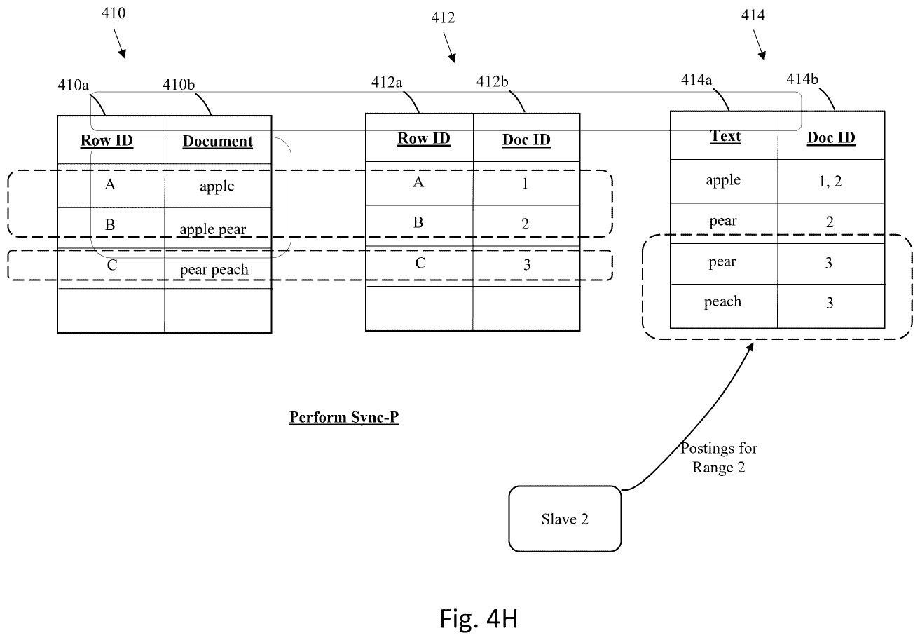

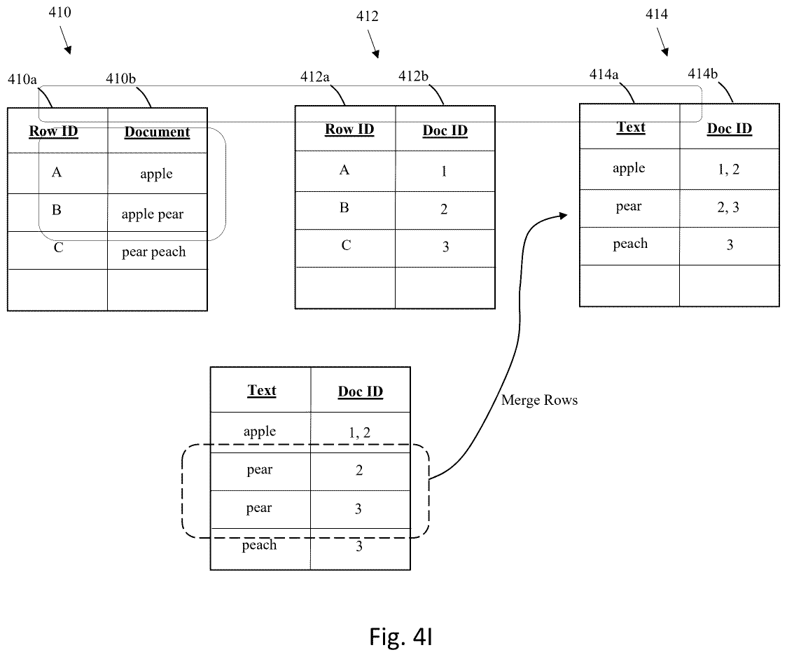

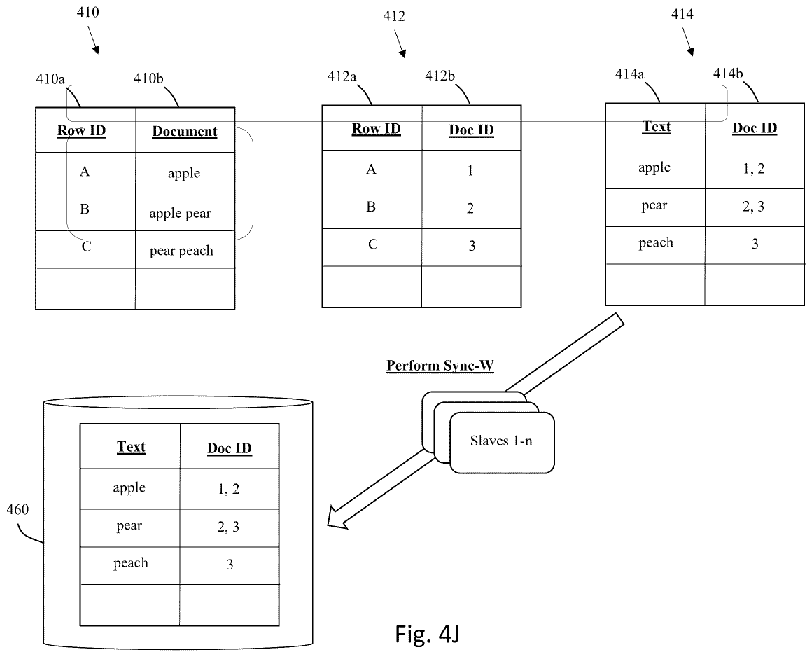

FIGS. 4A-J provide an illustrative example of this process. As shown in FIG. 4A, table 410 is a data table that may be used to store documents in the system. Table 410 includes a column 410a to hold Row IDs for the rows in table 410. Each row in table 410 may store a document in column 410b. For example, column 410b may be implemented as a Blob or Clob column. Column 410b may also include pointers that point to the storage location of a given document that is held elsewhere.

Table 412 is used to hold mappings between Row IDs and Doc IDs. As previously explained, Doc IDs can be implemented as monotonically increasing ID values that are absolute values and thus are assigned/allocated uniquely to documents within the system. This is in contrast to alternative approaches where these numbers are not absolute and thus may be locally assigned. The advantage of using absolute/unique values for the Doc IDs is that this avoids the later costs to merge the non-unique or subsetted values together at a later point in time, albeit at the expense of the upfront costs to allocate the absolute ID values. Table 412 include a first column 412a to hold Row ID values and a second column 412b to hold Doc ID values.

Table 414 is used to hold the inverted index content for specific text items with regards to Doc IDs. Column 414a identifies a text item/value. Column 414b is used to hold the Doc IDs that correspond to a text value. A given row in table 414 would pertain to a given text value, where column 414a hold that text value and column 414b identifies the Doc IDs for documents where that text value can be found.

FIG. 4B shows when a user seeks to perform update or insert operations to store documents within the system. Here, one or more user DML operations are performed to insert documents into the system, where a first document includes the text “apple”, a document includes the text “apple” and “pear”, and a third document includes the text “pear” and “peach”.

FIG. 4C shows the results of inserting rows into table 410 for these documents. In particular, a row has been inserted with the Row ID value of A for the document that includes the text “apple”. Similarly, another row has been inserted with the Row ID value of B for the document that includes the text “apple” and “pear”. A third row has been inserted with the Row ID value of C for the document that includes the text “pear” and “peach”.

At this point, the system will attempt to perform index maintenance to update the index table 414 to reflect these new additions to table 410. The first stage of the maintenance process is Sync-M to perform mappings of Row IDs to Doc IDs.

FIG. 4D shows the Sync-M stage as applied to the newly added rows in table 410. Here, a Doc ID assignment module 450 will assign new Doc IDs to each of the documents that were added to table 410. Specifically, the document for the row having Row ID A will be assigned to Doc ID 1, the document for the row having Row ID B will be assigned to Doc ID 2, and the document for the row having Row ID C will be assigned to Doc ID 3. This is reflected in the update to table 412, which shows newly inserted rows, where column 412a shows the Row ID and column 412b shows the corresponding Doc ID for that Rows ID. Here, the row with Row ID A in column 412a will include the Doc ID value 1 in column 412b. Similarly, the row with Row ID B in column 412a will include the Doc ID value 2 in column 412b. The row with Row ID C in column 412a will include the Doc ID value 3 in column 412b.

Next, the Sync-R phase is performed to determine ranges within set of work to process for the maintenance. The general idea is that smaller pieces of work will be created from the larger body of work that is necessary for the maintenance tasks. By creating smaller pieces of work, the overall workload can then be sub-divided among multiple processing entities.

One way to implement the Sync-R phase is to identify discrete ranges of Doc IDs from among the overall set of Doc IDs that need to be processed. Any suitable approach can be taken to determine the set of Doc IDs in each range. For load balancing purposes, one approach is to simply create ranges that have equal numbers (or similar number) of documents. Another approach is to analyze amount of work that is likely to be required for each document, and to divide up the items to make the workloads equivalent between the ranges even if the number of documents in each range is not equal, e.g., where a first range has a smaller number of larger documents but a second range has a larger number of smaller documents.

As shown in FIG. 4E, the illustrative example has created two ranges of work. Here, the documents associated with Doc IDs 1 and 2 are placed into a first range, and the document associated with Doc ID 3 is placed into a second range.

The next task is to perform Sync-P to create/maintain the inverted index. This action will go through each of the documents to identify text of interest, and to index that text within the index table.

Since ranges were previously created in the Sync-R phase, these ranges can now be assigned to different worker/slave processes to perform the Sync-P phase. It is this aspect of assigning Sync-P work in parallel to multiple slave processes that provides one of the advantages to the present approach. This is because the present approach has recognized that this phase of activity can be performed in a concurrent manner (once the previous stages such as Sync-R has been performed), thereby significantly improving the performance of the maintenance tasks, and allowing the overall approach to scale to even very high workloads.

As shown in FIG. 4F, the different ranges that were identified in the previous stage(s) are assigned to different slave processes. Here, range 1 has been assigned to slave 1, and range 2 has been assigned to slave 2. As shown in FIG. 4G, slave 1 has processed range 1 for the document(s) associated with Doc IDs 1 and 2, and has created rows in the index table 414 that correspond to these documents. In particular, a first row is created in table 414 that identifies “apple” as the text of interest in column 414a, and identifies Doc IDs 1 and 2 in column 4514b as corresponding to this text. A second row is created in table 414 that identifies “pear” as the text of interest in column 414a, and identifies Doc ID 2 in column 4514b as corresponding to this text.

As shown in FIG. 4H, slave 2 has processed range 2 for the document(s) associated with Doc ID 3. This slave 2 has created rows in the index table 414 that correspond to this document. In particular, a row is created in table 414 that identifies “pear” as the text of interest in column 414a, and identifies Doc ID 3 in column 4514b as corresponding to this text. Another row is created in table 414 that identifies “peach” as the text of interest in column 414a, and identifies Doc ID 3 in column 4514b as corresponding to this text.

At this point, because each slave has operated independently of each other, it is possible that multiple rows will be created in the index for the same text. Here, the text “peach” has two rows in the index table, one created by each of the slaves 1 and 2. A merger operation may be performed to merge these rows together. Since this table currently exists in memory, it is possible to performed updates to these in-memory representations of the table to merge these rows together, e.g., as shown in FIG. 4I.

Next, the Sync-W stage is performed to write the inverted index to disk. As shown in FIG. 4J, the in-memory representation of table 414 is written to disk 460. Multiple slaves may be employed to perform this operation in parallel. It is noted that the merger operation described above may be performed at the Sync-W stage when writing the in-memory representation of table 414 to disk.

In some embodiments, the system may implement a Scheduler background process that wakes up periodically (e.g., every 3 seconds) or on-demand to allocate different stages of Sync for different indexes in the system to worker processes (slaves). The idea is that the system should collect up a set of work before engaging in the maintenance tasks, with a suitable time period selected to optimize the size of the workload for the maintenance operations.

In some cases, the Sync-M processes are triggered by COMMITs. There could be only one Sync-M processes running at a time for a given index. Sync-M processes are run with the 3 second frequency even if the Scheduler wakes up more frequently to allow for a sizable range generation, which will serve as a source of concurrency for Sync-P. Once Sync-M finishes, it triggers Sync-R and wakes up the Scheduler.

Similarly to Sync-M, only one Sync-R is allowed to run at a time for a given index. Since both Sync-M and Sync-R should be relatively short in duration, this does not significantly limit the concurrency of the overall system. With proper coordination of conflicting stages that is performed by the Scheduler, the contention in the system can be minimized.

Once Sync-R finishes it triggers multiple Sync-P processes. Each process will work on one range and once ready will return back to the Scheduler which could schedule one more round of Sync-P is there are available ranges and worker slaves. This parallelism may similarly be applied to the Sync-W phase. This technique achieves fluid concurrency where the degree of parallelism changes during execution.

Therefore, this approach provides an asynchronous maintenance mechanisms that can increase data ingestion rates—making auxiliary data structures such as indexes virtually free from the outward effects of data maintenance. In other words, data ingestion rates would be comparable for tables with or without indexes and will not depend on the number of indexes. Costly index maintenance was traditionally used a one of the motivating factors for in-memory databases. Thus, the current asynchronous index maintenance techniques could be viewed as competing with in-memory databases when relatively selective queries are used (returning less than 1-5% of the data) which is usually the case for Text search applications.

This next section of the disclosure will describe an approach to implement lock-free interactions between user operations and the maintenance operations.

In general, database applications and/or end users interact with a database system by submitting commands that cause the database to perform operations on data stored in a database. For the database server to process the commands, the commands typically conform to a database language supported by the database server. An example of a commonly used database language supported by many database servers is known as the Structured Query Language (SQL). A database “transaction” corresponds to a unit of activity performed at the database that may include any number of different statements or commands for execution. ACID (Atomicity, Consistency, Isolation, Durability) is a set of properties that guarantees that database transactions are processed reliably. Atomicity requires that each transaction is all or nothing; if any part of the transaction fails, then the database state should not be changed by the transaction. Consistency requires that a database remains in a consistent state before and after a transaction. Isolation requires that other operations cannot see the database in an intermediate state caused by the processing of a current transaction that has not yet committed. Durability requires that, once a transaction is committed, the transaction will persist.

Since the multiple instances in the system are permitted to access the same set of shared underlying content within the database, a synchronization mechanism is usually provided to prevent conflicts when the multiple instances seek to access the same shared resources at the same time. Lock management is a common approach that is used to synchronize accesses to the shared resources. A resource corresponds to any object or entity to which shared access must be controlled. For example, the resource can be a file, a record, an area of shared memory, a database row/column, or anything else that can be shared by multiple entities in a system. An entity can acquire locks on the database as a whole, or only on particular parts of the database. When any of the instances seek to access data within the database, a lock may need to be acquired using the lock management system to avoid inconsistent access to that data. There are many types of locks that may potentially be taken on the data. For example, the exclusive (EX or X) lock is a lock that can be held by only a single entity, which allows read and update access to the resource while preventing others from having any access to that locked resource. A shared(S) lock can be held by multiple entities at the same time, which allows an entity holding the lock to read the resource while preventing other entities from updating that resource.

Locking may become an issue between the operations being performed by the maintenance tasks (e.g., DML operations) and any user requests (e.g., for DDL operations) to make changes that may conflict with locks that were held for the maintenance DML operations. The conflicts over lock may result in delays or errors for users that seek to perform DDL operations.

To explain, consider that every database has a set of Data Definition Language (DDL) statements that work with the metadata. Typically, these statements require exclusive access to the metadata making it hard to execute them on busy systems. A common approach to dealing with this are so called ONLINE DDLs. They perform all the work without any locks and then try to acquire exclusive lock once all the work has been done. The lock is usually short and thus does not block other activities for a long time. The most typical activity in this case are data modifications (DMLs or Data Manipulation Language statements). There could be a lot of them but they are typically short which allows DDLs to get their turn in getting a lock. Normally only one DDL can proceed at a time making all others wait.

Modern RDBMS in addition to user requests, performs a lot of automated activities (such as maintenance activities on inverted indexes) that could also require exclusive access to the metadata. This makes it significantly harder for user DDLs to proceed. It also makes the system hardly usable as end users do not control or even aware of the automated activities. Thus, there needs to be a way to coordinate the execution of automated tasks and user DDLs. In some embodiments, the preferred way is to let DDLs execute without wait (or possibly with a very small wait) even if at the expense of the restartable automated tasks.

Some embodiments provide a technique that allows user DDLs to always proceed even when there are conflicting concurrent background automation tasks (such as asynchronous index maintenance). This is done by gracefully terminating backgrounds with the use of an IPC (inter-process communication) channel between a DDL and all automation processes. Background processes periodically check the channel for an interrupt message and once found throw an exception that leads to graceful unwinding of the stack forcing a rollback that releases the lock. Thus, all slaves are channel subscribers and the DDL process is the channel publisher. This algorithm kicks in only when the lock could not be acquired in a DDLs. This is when the process subscribes to the channel as a publisher and then wait for relevant slaves to release the locks. At this point the lock will be retried but with NOWAIT.

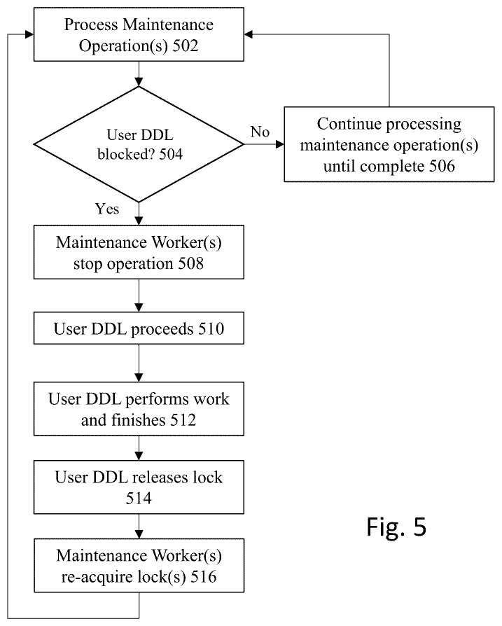

FIG. 5 shows a flowchart of an approach to implement some embodiments of the invention. At 502, maintenance operations are executed by the system. These operations include, for example, any operations to implement any of the Sync M, R, P, or W phases as described above. Such operations may involve DML operations to perform actions upon one or more tables within a database system. As such, locks may be acquired upon one or more database structures/objects during for the maintenance-related DML operations. The locks are acquired by the worker/slaves that are assigned to perform the operations.

At 504, a determination is made whether a user DDL operation would be blocked by the maintenance DML operations. It is possible that the maintenance-related DML operations will block the ability to execute a user DDL operation. For example, consider the situation where the worker/slave holds a lock on a data table 410 to insert rows into that table to ingest documents into the database system or to maintain any corresponding inverted indexes. The locks are held so that workers/slaves can perform DML operations on the table(s). However, at the same time, a user may seek to perform a DDL operations on the table. For example, the user may seek to rename the table, to add a column to the table, or to apply some sort of encryption or compression to the table. At this moment, since that the DML operations currently hold a lock on the table, this would block the user DDL operation from being performed.

If the determination at 504 is that a user DDL is not blocked, then the worker/slaves will continue operating at 506 to perform their maintenance-related DML operations.

However, if the determination at 504 is that there is a user DDL that is blocked, then the current embodiment will provide a lock-free approach to gracefully allow the user DDL to proceed. With certain embodiments of the invention, the worker/slaves for the maintenance operations will open an IPC (inter-process communications) mechanism when it is operating. The worker/slave entities will listen on the IPC for any notification or request that is indicative of a conflict between the DML operation by the worker/slave against any other user requests that may conflict with the worker/slave operations.

In the example conflict situation described above, a message will be sent to the IPC to let the worker/slaves know that there is a user DDL that would like to proceed. When the worker/slave receives this message on the IPC, the worker/slave will, at 508, then halt its maintenance operations. This action may be conducted in any number of ways so that the halting is “graceful”. For example, the worker/slave can continue operating to an efficient stopping point, and then stop its operations. An example is when a worker is close to finishing a current phase of operation, and will continue to the end of that phase but will not start the next phase. The worker will stay alive, and therefore retain its current operating state in memory, but will release its conflicting lock to the database object that is blocking the user DDL.

At 510, the user DDL can then acquire the necessary lock and will proceed to perform the DDL operation. At 512, the user DDL will perform its work until it is finished. At 514, the user DDL will then release its lock.

At 516, the worker/slave can then reacquire the lock to the resource and will proceed with its work. In some situations, since the worker/slave had not lost its previous state, the worker/slave can continue back to 502 where it left off. In other situations, it is possible that the worker/slave may not be able to continue from where it previous stopped, but may need some sort of a restart. For example, if the version of certain metadata pertaining to the database object(s) expected by the worker/slave is no longer current (e.g., because the sequence number associated with the metadata is now out-of-date), then the worker/slave may need to restart to make sure no inconsistencies are introduced into the system.

This portion of the disclosure will now describe an improved approach to process highly concurrent tasks within a database system using an event queue.

To explain the problem being addressed, consider that inter-process communication is a very common problem in concurrent systems. When processes do not wait for each other, it is common to use shared memory queues. However, when the volume of requests is very high the queue can easily run out of memory while queueing requests. Queues typically have critical sections that limit the concurrency by creating contention points. For some domains it is possible to evolve the idea of queues given additional constraints on the requests that will lead to no or very low contention with bounded memory requirements.

By way of example, consider the text maintenance operations described above. The system needs to have a way to track the DML changes that are being made by the workers/slaves, so that as one stage of operations finishes, the system is ready to proceed with subsequent stages of operations.

To address these problems in some embodiments of the invention, an event queue is provided that is a shared memory-based collection data structure that is used for communicating between concurrent foreground processes and a single background process—the Scheduler—as a way to initiate asynchronous processing in response to various events. This is a one-way communication—from the foregrounds to the background.

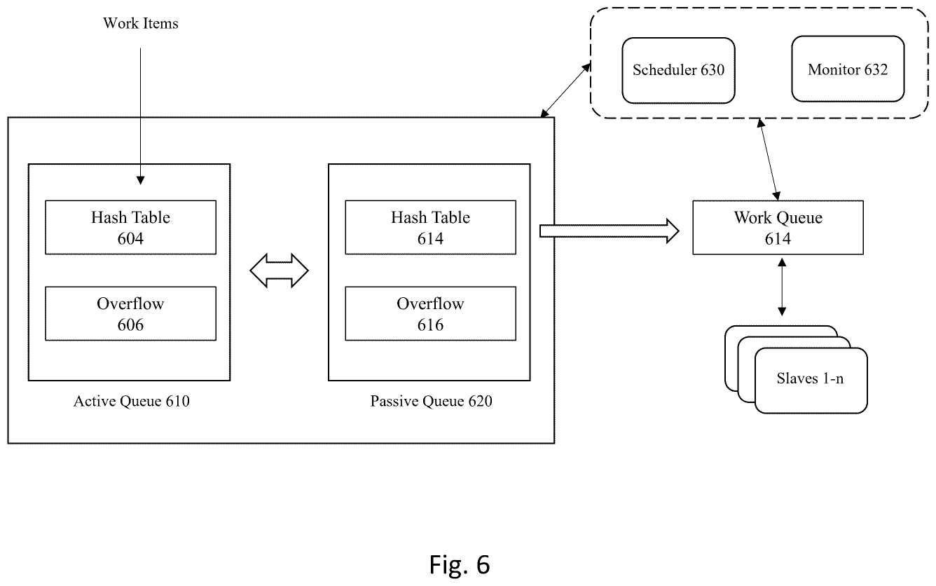

FIG. 6 shows an example event queue according to some embodiments of the invention. The event queue actually comprises two separate queues, including an active queue 610 and a passive queue 620.

The general idea is that new work items are loaded into the active queue 610. Therefore, the active queue 610 is where any new items will be identified and located into the event queue. The passive queue 620 is where previously loaded work items are staged and ready to be looked at for downstream processing by workers/slaves. When the active queue 610 becomes full of new items, the two queues will swap positions, such that the previous active queue will become the passive queue, and the previous passive queue will become the new active queue. The items in the new passive queue can then be offloaded into the work queue 614 for processing by the workers/slaves. In this way, there is a constant rotation between the two queues.

Within the active queue, work items can be loaded into a hash table 604 by hashing to a particular location. For example, hashing may be performed on a key comprising an object ID and an event ID. This approach provides several advantages. First, this allows the work items to be loaded into the queue in a mostly lock-free manner since the work item can be simply hashed to its corresponding location in the queue. Secondly, this approach inherently provide de-duplication of work items since the same work items will hash to the exact same location in the queue.

To the extent a collision occurs, then the colliding item will be placed into the overflow structure 606. This is the only time that a lock may be needed in the system, thus making the approach “mostly” lock-free and not absolutely lock-free. The event queue is therefore a combination of the items from both the hash table 604 and the overflow 606.

In operation, a scheduler 630 will schedule the movement of items from the passive queue 614 into the work queue. This schedule should be frequent enough to permit the passive queue to be emptied in time so that when the active queue becomes full, it is possible to perform a switch with the passive queue.

When the work items are copied from the passive queue into the work queue, they are sorted and order based upon timestamps associated with the work items. This will now create an ordered queue in the work queue 614 from the previously un-ordered items in the hash table 614 of the passive queue 620. The slaves 1-n can then take work items from the work queue 614 to be processed to perform the maintenance tasks in the system.

A monitor 632 can be employed in the system to verify that work items are properly being handled. If the monitor determined that a work item that was supposed to be handled was not completed, then the monitor can add that work item back into the active queue to be processed in the suture by another worker/slave. Given the inherent de-duplication of the event queue, the monitor can safely add the same work items multiple times and not worry about the same work being duplicatively performed.

In the current embodiments, elements of the event queue can correspond to events for maintenance of a text index or index partition. For example, the events may represent different stages of SYNC that are triggered by COMMITs. As other examples, OPTIMIZE and UPGRADE events may be used to trigger corresponding operations on the index or index partition.

As noted above, the event queue is used to capture only one occurrence of a given event until it is processed by the Scheduler at which point it can be added to the Event Queue again. When adding an event that already exists in the queue it is simply ignored. For example, when looking at COMMITs then from the Event Queue perspective, the system is only interested in the fact that the index has changed, and not interested in how many COMMITs were issued. This is an indication that the system needs to handle all the changes. Once the event is processed it is removed from the queue and thus can be added again when the next COMMIT happens.

Another important property of the Event Queue besides deduplication is that it is potentially not reliable-events could be dropped without being processed for various reasons. This drawback is compensated by having a separate background process—the Monitor—that periodically checks for dropped events and adds them back to the Event Queue. For the types of events that are handled for maintenance operations, this is an adequate solution since the system can function correctly without processing some (or even all) of the events but possibly not at an optimal performance. Dropped events should be fairly rare and with the help of the Monitor are eventually compensated. Allowing dropped events simplifies the Event Queue design and delivers higher concurrency. Concurrency is one of the main requirements of the Event Queue-ideally it should be non-blocking for the common case or only minimally blocking so that it can handle very high number of concurrent sessions performing DMLs on the index.

Both the Scheduler and the Monitor are invoked in two ways. The most common is a timeout. The Scheduler is invoked every designated time period (e.g., 3 seconds) and the Monitor another time period (e.g., every 3 hours).

### System Architecture Overview

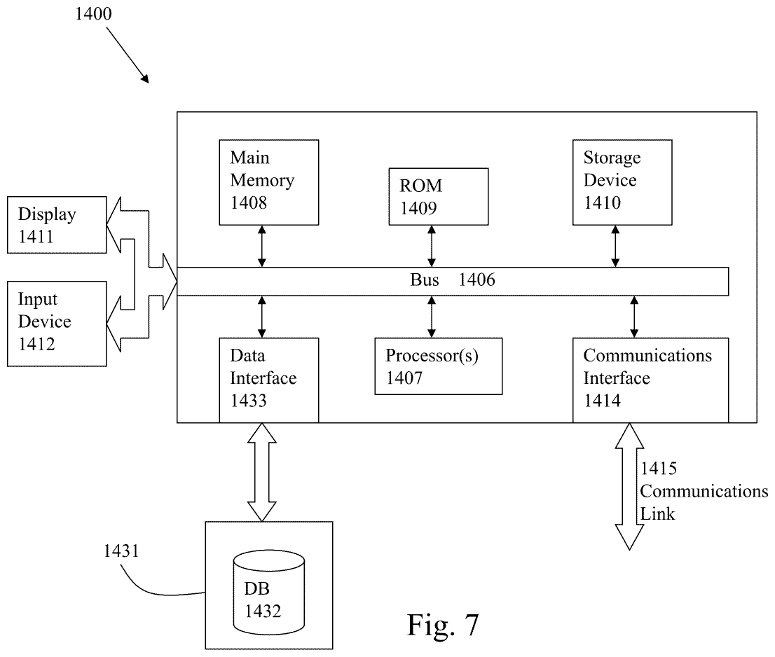

FIG. 7 is a block diagram of an illustrative computing system 1400 suitable for implementing an embodiment of the present disclosure. Computer system 1400 includes a bus 1406 or other communication mechanism for communicating information, which interconnects subsystems and devices, such as processor 1407, system memory 1408 (e.g., RAM), static storage device 1409 (e.g., ROM), disk drive 1410 (e.g., magnetic or optical), communication interface 1414 (e.g., modem or Ethernet card), display 1411 (e.g., CRT or LCD), input device 1412 (e.g., keyboard), data interface 1433, and cursor control.

According to some embodiments of the disclosure, computer system 1400 performs specific operations by processor 1407 executing one or more sequences of one or more instructions contained in system memory 1408. Such instructions may be read into system memory 1408 from another non-transitory computer readable/usable medium, such as static storage device 1409 or disk drive 1410. In alternative embodiments, hard-wired circuitry may be used in place of or in combination with software instructions to implement the disclosure. Thus, embodiments of the disclosure are not limited to any specific combination of hardware circuitry and/or software. In some embodiments, the term “logic” shall mean any combination of software or hardware that is used to implement all or part of the disclosure.

The term non-transitory “computer readable medium” or “computer usable medium” as used herein refers to any medium that participates in providing instructions to processor 1407 for execution. Such a medium may take many forms, including but not limited to, non-volatile media and volatile media. Non-volatile media includes, for example, optical or magnetic disks, such as disk drive 1410. Volatile media includes dynamic memory, such as system memory 1408.

Common forms of non-transitory computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read.

In an embodiment of the disclosure, execution of the sequences of instructions to practice the disclosure is performed by a single computer system 1400. According to other embodiments of the disclosure, two or more computer systems 1400 coupled by communication link 1410 (e.g., LAN, PTSN, or wireless network) may perform the sequence of instructions required to practice the disclosure in coordination with one another.

Computer system 1400 may transmit and receive messages, data, and instructions, including program, e.g., application code, through communication link 1415 and communication interface 1414. Received program code may be executed by processor 1407 as it is received, and/or stored in disk drive 1410, or other non-volatile storage for later execution. A database 1432 in a storage medium 1431 may be used to store data accessible by the system 1400 via data interface 1433.

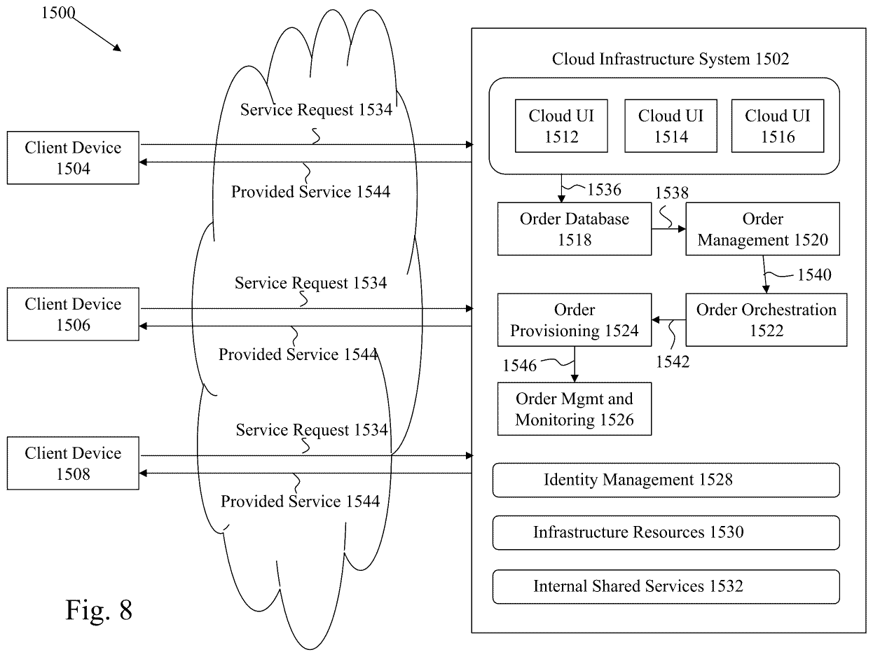

FIG. 8 is a simplified block diagram of one or more components of a system environment 1500 by which more efficient access to ordered sequences in a clustered database environment is provided, in accordance with an embodiment of the present disclosure. In the illustrated embodiment, system environment 1500 includes one or more client computing devices 1504, 1506, and 1508 that may be used by users to interact with a cloud infrastructure system 1502 that provides cloud services. The client computing devices may be configured to operate a client application such as a web browser, a proprietary client application, or some other application, which may be used by a user of the client computing device to interact with cloud infrastructure system 1502 to use services provided by cloud infrastructure system 1502.

It should be appreciated that cloud infrastructure system 1502 depicted in the figure may have other components than those depicted. Further, the embodiment shown in the figure is only one example of a cloud infrastructure system that may incorporate an embodiment of the disclosure. In some other embodiments, cloud infrastructure system 1502 may have more or fewer components than shown in the figure, may combine two or more components, or may have a different configuration or arrangement of components. Client computing devices 1504, 1506, and 1508 may be devices similar to those described. Although system environment 1500 is shown with three client computing devices, any number of client computing devices may be supported. Other devices such as devices with sensors, etc. may interact with cloud infrastructure system 1502.

Network(s) 1510 may facilitate communications and exchange of data between client computing devices 1504, 1506, and 1508 and cloud infrastructure system 1502. Each network may be any type of network familiar to those skilled in the art that can support data communications using any of a variety of commercially-available protocols. Cloud infrastructure system 1502 may comprise one or more computers and/or servers.

In certain embodiments, services provided by the cloud infrastructure system may include a host of services that are made available to users of the cloud infrastructure system on demand, such as online data storage and backup solutions, Web-based e-mail services, hosted office suites and document collaboration services, database processing, managed technical support services, and the like. Services provided by the cloud infrastructure system can dynamically scale to meet the needs of its users. A specific instantiation of a service provided by cloud infrastructure system is referred to herein as a “service instance.” In general, any service made available to a user via a communication network, such as the Internet, from a cloud service provider's system is referred to as a “cloud service.” Typically, in a public cloud environment, servers and systems that make up the cloud service provider's system are different from the customer's own on-premises servers and systems. For example, a cloud service provider's system may host an application, and a user may, via a communication network such as the Internet, on demand, order and use the application.

In some examples, a service in a computer network cloud infrastructure may include protected computer network access to storage, a hosted database, a hosted web server, a software application, or other service provided by a cloud vendor to a user, or as otherwise known in the art. For example, a service can include password-protected access to remote storage on the cloud through the Internet. As another example, a service can include a web service-based hosted relational database and a script-language middleware engine for private use by a networked developer. As another example, a service can include access to an email software application hosted on a cloud vendor's web site.

In certain embodiments, cloud infrastructure system 1502 may include a suite of applications, middleware, and database service offerings that are delivered to a customer in a self-service, subscription-based, elastically scalable, reliable, highly available, and secure manner.

In various embodiments, cloud infrastructure system 1502 may be adapted to automatically provision, manage and track a customer's subscription to services offered by cloud infrastructure system 1502. Cloud infrastructure system 1502 may provide the cloud services via different deployment models. For example, services may be provided under a public cloud model in which cloud infrastructure system 1502 is owned by an organization selling cloud services and the services are made available to the general public or different industry enterprises. As another example, services may be provided under a private cloud model in which cloud infrastructure system 1502 is operated solely for a single organization and may provide services for one or more entities within the organization. The cloud services may also be provided under a community cloud model in which cloud infrastructure system 1502 and the services provided by cloud infrastructure system 1502 are shared by several organizations in a related community.

The cloud services may also be provided under a hybrid cloud model, which is a combination of two or more different models.

In some embodiments, the services provided by cloud infrastructure system 1502 may include one or more services provided under Software as a Service (Saas) category, Platform as a Service (PaaS) category, Infrastructure as a Service (IaaS) category, or other categories of services including hybrid services. A customer, via a subscription order, may order one or more services provided by cloud infrastructure system 1502. Cloud infrastructure system 1502 then performs processing to provide the services in the customer's subscription order.

In some embodiments, the services provided by cloud infrastructure system 1502 may include, without limitation, application services, platform services and infrastructure services. In some examples, application services may be provided by the cloud infrastructure system via a SaaS platform. The SaaS platform may be configured to provide cloud services that fall under the SaaS category. For example, the SaaS platform may provide capabilities to build and deliver a suite of on-demand applications on an integrated development and deployment platform. The SaaS platform may manage and control the underlying software and infrastructure for providing the SaaS services. By utilizing the services provided by the SaaS platform, customers can utilize applications executing on the cloud infrastructure system. Customers can acquire the application services without the need for customers to purchase separate licenses and support. Various different SaaS services may be provided. Examples include, without limitation, services that provide solutions for sales performance management, enterprise integration, and business flexibility for large organizations.

In some embodiments, platform services may be provided by the cloud infrastructure system via a PaaS platform. The PaaS platform may be configured to provide cloud services that fall under the PaaS category. Examples of platform services may include without limitation services that allow organizations to consolidate existing applications on a shared, common architecture, as well as the ability to build new applications that leverage the shared services provided by the platform. The PaaS platform may manage and control the underlying software and infrastructure for providing the PaaS services. Customers can acquire the PaaS services provided by the cloud infrastructure system without the need for customers to purchase separate licenses and support.

By utilizing the services provided by the PaaS platform, customers can employ programming languages and tools supported by the cloud infrastructure system and also control the deployed services. In some embodiments, platform services provided by the cloud infrastructure system may include database cloud services, middleware cloud services, and Java cloud services. In one embodiment, database cloud services may support shared service deployment models that allow organizations to pool database resources and offer customers a Database as a Service in the form of a database cloud. Middleware cloud services may provide a platform for customers to develop and deploy various business applications, and Java cloud services may provide a platform for customers to deploy Java applications, in the cloud infrastructure system.

Various different infrastructure services may be provided by an laaS platform in the cloud infrastructure system. The infrastructure services facilitate the management and control of the underlying computing resources, such as storage, networks, and other fundamental computing resources for customers utilizing services provided by the SaaS platform and the PaaS platform.

In certain embodiments, cloud infrastructure system 1502 may also include infrastructure resources 1530 for providing the resources used to provide various services to customers of the cloud infrastructure system. In one embodiment, infrastructure resources 1530 may include pre-integrated and optimized combinations of hardware, such as servers, storage, and networking resources to execute the services provided by the PaaS platform and the SaaS platform.

In some embodiments, resources in cloud infrastructure system 1502 may be shared by multiple users and dynamically re-allocated per demand. Additionally, resources may be allocated to users in different time zones. For example, cloud infrastructure system 1530 may allow a first set of users in a first time zone to utilize resources of the cloud infrastructure system for a specified number of hours and then allow the re-allocation of the same resources to another set of users located in a different time zone, thereby maximizing the utilization of resources.

In certain embodiments, a number of internal shared services 1532 may be provided that are shared by different components or modules of cloud infrastructure system 1502 and by the services provided by cloud infrastructure system 1502. These internal shared services may include, without limitation, a security and identity service, an integration service, an enterprise repository service, an enterprise manager service, a virus scanning and white list service, a high availability, backup and recovery service, service for enabling cloud support, an email service, a notification service, a file transfer service, and the like.

In certain embodiments, cloud infrastructure system 1502 may provide comprehensive management of cloud services (e.g., SaaS, PaaS, and laaS services) in the cloud infrastructure system. In one embodiment, cloud management functionality may include capabilities for provisioning, managing and tracking a customer's subscription received by cloud infrastructure system 1502, and the like.

In one embodiment, as depicted in the figure, cloud management functionality may be provided by one or more modules, such as an order management module 1520, an order orchestration module 1522, an order provisioning module 1524, an order management and monitoring module 1526, and an identity management module 1528. These modules may include or be provided using one or more computers and/or servers, which may be general purpose computers, specialized server computers, server farms, server clusters, or any other appropriate arrangement and/or combination.

In operation 1534, a customer using a client device, such as client computing devices 1504, 1506 or 1508, may interact with cloud infrastructure system 1502 by requesting one or more services provided by cloud infrastructure system 1502 and placing an order for a subscription for one or more services offered by cloud infrastructure system 1502. In certain embodiments, the customer may access a cloud User Interface (UI), cloud UI 1512, cloud UI 1514 and/or cloud UI 1516 and place a subscription order via these UIs. The order information received by cloud infrastructure system 1502 in response to the customer placing an order may include information identifying the customer and one or more services offered by the cloud infrastructure system 1502 that the customer intends to subscribe to.

After an order has been placed by the customer, the order information is received via the cloud UIs, 1512, 1514 and/or 1516. At operation 1536, the order is stored in order database 1518. Order database 1518 can be one of several databases operated by cloud infrastructure system 1502 and operated in conjunction with other system elements. At operation 1538, the order information is forwarded to an order management module 1520. In some instances, order management module 1520 may be configured to perform billing and accounting functions related to the order, such as verifying the order, and upon verification, booking the order. At operation 1540, information regarding the order is communicated to an order orchestration module 1522. Order orchestration module 1522 may utilize the order information to orchestrate the provisioning of services and resources for the order placed by the customer. In some instances, order orchestration module 1522 may orchestrate the provisioning of resources to support the subscribed services using the services of order provisioning module 1524.

In certain embodiments, order orchestration module 1522 allows the management of business processes associated with each order and applies business logic to determine whether an order should proceed to provisioning. At operation 1542, upon receiving an order for a new subscription, order orchestration module 1522 sends a request to order provisioning module 1524 to allocate resources and configure those resources needed to fulfill the subscription order. Order provisioning module 1524 allows the allocation of resources for the services ordered by the customer. Order provisioning module 1524 provides a level of abstraction between the cloud services provided by cloud infrastructure system 1502 and the physical implementation layer that is used to provision the resources for providing the requested services. Order orchestration module 1522 may thus be isolated from implementation details, such as whether or not services and resources are actually provisioned on the fly or pre-provisioned and only allocated/assigned upon request.

At operation 1544, once the services and resources are provisioned, a notification of the provided service may be sent to customers on client computing devices 1504, 1506 and/or 1508 by order provisioning module 1524 of cloud infrastructure system 1502.

At operation 1546, the customer's subscription order may be managed and tracked by an order management and monitoring module 1526. In some instances, order management and monitoring module 1526 may be configured to collect usage statistics for the services in the subscription order, such as the amount of storage used, the amount data transferred, the number of users, and the amount of system up time and system down time.

In certain embodiments, cloud infrastructure system 1502 may include an identity management module 1528. Identity management module 1528 may be configured to provide identity services, such as access management and authorization services in cloud infrastructure system 1502. In some embodiments, identity management module 1528 may control information about customers who wish to utilize the services provided by cloud infrastructure system 1502. Such information can include information that authenticates the identities of such customers and information that describes which actions those customers are authorized to perform relative to various system resources (e.g., files, directories, applications, communication ports, memory segments, etc.) Identity management module 1528 may also include the management of descriptive information about each customer and about how and by whom that descriptive information can be accessed and modified.

In the foregoing specification, the disclosure has been described with reference to specific embodiments thereof. It will, however, be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are, accordingly, to be regarded in an illustrative rather than restrictive sense. In addition, an illustrated embodiment need not have all the aspects or advantages shown. An aspect or an advantage described in conjunction with a particular embodiment is not necessarily limited to that embodiment and can be practiced in any other embodiments even if not so illustrated. Also, reference throughout this specification to “some embodiments” or “other embodiments” means that a particular feature, structure, material, or characteristic described in connection with the embodiments is included in at least one embodiment. Thus, the appearances of the phrase “in some embodiment” or “in other embodiments” in various places throughout this specification are not necessarily referring to the same embodiment or embodiments.

1. A method, comprising:
receiving a collection of changes to a document collection in a database system;
determining actions to take to maintain an inverted index for the document collection at least by processing the collection of changes to generate entries in a table corresponding to the collection of changes and partitioning the entries in the table for allocation to different worker entities of a plurality of worker entities; and
asynchronously performing the actions to maintain the inverted index, wherein one or more maintenance phases are performed concurrently by the plurality of worker entities.

2. The method of claim 1, wherein the one or more maintenance phases comprises a mapping phase to map row IDs to document IDs.

3. The method of claim 1, wherein the one or more maintenance phases comprises a range phase to identify different ranges of work among document identifiers.

4. The method of claim 1, wherein the one or more maintenance phases comprising a posting phase to create postings for the inverted index.

5. The method of claim 4, wherein the posting phase to create the postings for the inverted index is performed in parallel by multiple processing entities.

6. The method of claim 5, wherein merging is performed to merge together multiple entries for same text in the inverted index.

7. The method of claim 6, wherein the merging is performed either in-memory or when writing the postings to persistent storage.

8. The method of claim 1, wherein the one or more maintenance phases comprising a writing phase to write in-memory postings for the inverted index to persistent storage.

9. A system, comprising:
a processor; and
a memory for holding programmable code, wherein the programmable code includes instructions which, when executed by the processor, cause the processor to perform a set of acts that comprises: receiving a collection of changes to a document collection in a database system; determining actions to take to maintain an inverted index for the document collection at least by processing the collection of changes to generate entries in a table corresponding to the collection of changes and partitioning the entries in the table for allocation to different worker entities of a plurality of worker entities; and asynchronously performing the actions to maintain the inverted index, wherein one or more maintenance phases are performed concurrently by the plurality of worker entities.

10. The system of claim 9, wherein the one or more maintenance phases comprises a mapping phase to map row IDs to document IDs.

11. The system of claim 9, wherein the one or more maintenance phases comprises a range phase to identify different ranges of work among document identifiers.

12. The system of claim 9, wherein the one or more maintenance phases comprising a posting phase to create postings for the inverted index.

13. The system of claim 12, wherein the posting phase to create the postings for the inverted index is performed in parallel by multiple processing entities.

14. The system of claim 9, wherein the one or more maintenance phases comprising a writing phase to write in-memory postings for the inverted index to persistent storage.

15. A computer program product embodied on a non-transitory computer readable medium, the non-transitory computer readable medium having stored thereon a sequence of instructions which, when executed by a processor, causes the processor to perform a set of acts, the set of acts comprising:
receiving a collection of changes to a document collection in a database system;
determining actions to take to maintain an inverted index for the document collection at least by processing the collection of changes to generate entries in a table corresponding to the collection of changes and partitioning the entries in the table for allocation to different worker entities of a plurality of worker entities; and
asynchronously performing the actions to maintain the inverted index, wherein one or more maintenance phases are performed concurrently by the plurality of worker entities.

16. The computer program product of claim 15, wherein the one or more maintenance phases comprises a mapping phase to map row IDs to document IDs.

17. The computer program product of claim 15, wherein the one or more maintenance phases comprises a range phase to identify different ranges of work among document identifiers.

18. The computer program product of claim 15, wherein the one or more maintenance phases comprising a posting phase to create postings for the inverted index.

19. The computer program product of claim 18, wherein the posting phase to create the postings for the inverted index is performed in parallel by multiple processing entities.

20. The computer program product of claim 15, wherein the one or more maintenance phases comprising a writing phase to write in-memory postings for the inverted index to persistent storage.
